(19) United States
(12) Patent Application Publication
(10) Pub. No.: US 2006/0051452 A1
(43) Pub. Date: Mar. 9, 2006

(54) Injection molding equipment having molded article ejector, and mehtod

(75) Inventors: John H Woller, Cushing, WI (US); John W McNally, Grantsburg, WI (US); Wayne A Shakal, Taylors Falls, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Advance Tool, Inc., Blaine, MN (US)

(21) Appl. No.: 10/527,653

(22) PCT Filed: Sep. 12, 2003
(86) PCT No.: PCT/US03/28677

§ 371 Date: Mar. 14, 2005

Related U.S. Application Data
(60) Provisional application No. 60/410,530, filed on Sep. 13, 2002.

(51) Int. Cl. B29C 45/40

(52) U.S. Cl. 425/556

(57) ABSTRACT

Molding equipment for an injection molding machine and particularly adapted for ejection of a molded article from a mold core. Mold cores borne by a rotatable turret are brought into position in respective cavities formed in one or more mold halves. The turret and mold halves are so configured that when one core is in registration with the cavity of that mold half, another core carrying a previously molded article is positioned away from the mold halves for ejection of the article. The equipment includes an ejector having cooperating, molded article-engaging portions, at least one of the portions being moveable in a first direction to close upon another portion of the ejector to encounter the molded article, and the ejector portions, when closed, being moveable in a second, different direction to expel the molded articles from the cores upon which they were molded.

### CROSS REFERENCE TO RELATED APPLICATIONS

This application is based upon and derives priority from Provisional Application Ser. No. 60/410,530, filed Sep. 13, 2002.

### FIELD OF THE INVENTION

The invention relates to equipment for injection molding machines in general, and in particular to those machines carrying a rotatable turret positioned between movable and fixed platens and having mold cores from which molded articles are to be ejected.

### BACKGROUND OF THE INVENTION

Typical injection molding machines employ a mold core, a cavity mold, and an apparatus for removing molded articles from the mold. Molds may employ first and second mold halves in which one or both of the mold halves have confronting, recessed faces defining a cavity, and a core that is received between the mold halves and that extends into the cavity.

In a molding operation, the mold halves and core come together to form a shaped space that has the configuration of the article to be molded. Molten plastic is injected into this space under heat and pressure, and the article is allowed to cool within the shaped space. One mold half is separated from the other, the core is freed from each mold half, and the molded article that commonly is carried by the core is then ejected. The faster the cycle occurs, the greater the production rate of molded articles and the lower the per-article cost.

To improve production efficiencies, mold cores may be carried on a retractable turret that is positioned between the fixed and moveable platens of an injection molding machine, the platens carrying fixed and movable mold halves, respectively. A turret of this type is described in Rees, et al., U.S. Pat. No. 4,330,257, the disclosure of which is incorporated herein by reference. To facilitate the removal of molded parts from cores, this patent describes the use of a stripper plate having openings that are penetrated by the respective cores. The stripper plate moves outwardly of the cores to dislodge the work pieces.

Stripper plates of the type described may often be less than satisfactory inasmuch as a stripper plate must be inserted over the core and remain in place during the molding operation. The stripper plate thus must be precisely machined to have perforations that are only very slightly larger than the core dimensions. Normal wear caused by movement between these parts leads to a looser fit of the stripper plate perforations over the cores. This, in turn, allows molten plastic to flow through these spaces, providing excessive flash and leading to rejected products. A stripper system that would avoid these problems would be of great benefit to the injection molding industry.

### SUMMARY OF THE INVENTION

The present invention utilizes a molded product ejector system that does not require a stripper plate in place during the molding operation. Rather, the present invention provides equipment including an ejector having opposed, cooperating, molded article-engaging portions for engaging a molded article on a core after the molded article and core have been removed from the cavity in which molding occurred. At least one of the ejector portions is movable in a first direction to close upon an opposed, article-engaging second ejector portion, and the ejector portions, when closed, are moveable in a second direction to cause the article to be ejected from the core.

Thus, in one embodiment, the invention equipment for an injection molding machine having a fixed platen and a platen movable toward and away from the fixed platen. First and second mold halves are carried respectively by the platens and close upon each other to provide a mold cavity between them as the movable platen is moved toward the fixed platen. Carried between the platens is a turret that has separate faces carrying cores receivable in respective mold cavities to define mold shapes for the reception of molten plastic, the turret being rotatable about an axis to bring respective cores into alignment with the cavity. The turret is moveable along the direction of movement of the movable platen to bring respective cores into and out of reception in respective cavities as the mold is closed and opened.

The turret and mold halves are so configured that when one core is received in a cavity, another core carrying a previously molded article is positioned outside of the cavities for ejection of that previously molded article. For this purpose, an ejector is provided, the ejector having opposed, cooperating, molded article-engaging portions. At least one of the ejector portions is moveable in a first direction to close upon an opposed article-engaging second ejector portion. When closed, the ejector portions are moveable as a unit in a second, different direction to cause the article to be ejected from the core upon which it was molded.

In a preferred embodiment, the mold halves include shields that extend into contact with the core received in the mold cavity when the mold is closed and plastic is injected, to shield a portion of the core and to provide a substantially plastic-free area on the core. The ejector portions are configured to close upon the substantially plastic-free area during an ejection cycle.

In another embodiment, the invention relates to a method for ejecting molded articles from an injection molding machine. The method comprises providing opposed mold halves and a mold core, and an ejector having portions closeable upon each other about the core. The method involves injection molding of an article about the core, and removing the core bearing the molded article from the mold halves. The ejector portions are closed upon each other, with at least one ejector moving in a first direction toward the core. The closed ejector portions as a unit are moved in a second, different direction to engage and eject the molded article from the core.

### BRIEF DESCRIPTION OF THE DRAWING

FIG. 1 is a perspective, broken-away, largely schematic view of mold halves and a turret in accordance with an embodiment of the invention;

FIG. 2 is a perspective, broken away, largely schematic view similar to that of FIG. 1 but showing a turret having four faces from which cores extend;

FIG. 3 is a broken away, perspective, largely schematic view of an embodiment similar to that shown in FIG. 1;

FIG. 4 is a broken away, perspective view of another embodiment of the invention;

FIG. 5 is a side view, largely schematic, of the device FIG. 4 in a closed position and rotated clockwise through 90°;

FIG. 6 is a view similar to that of FIG. 5 but showing the mold in a partially open position;

FIG. 7 is a view similar to that of FIGS. 5 and 6 but showing the mold in a fully opened position to enable rotation of the turret;

FIG. 8 is an exploded, perspective, largely schematic view showing ejectors employed in the inventions;

FIG. 9 is a side view schematic of the ejector assembly shown also in FIG. 8;

FIG. 10 is a side view schematic similar to that of FIG. 9 and showing a step in an ejection sequence;

FIG. 11 is a view similar to that of FIG. 10 but showing another step in an ejection sequence;

FIG. 12 is a computer-generated model, in perspective view, showing a mold half to be attached to a fixed platen;

FIG. 13 is a computer-generated representation of another mold half usable with the device FIG. 12 and illustrating core portions.

FIG. 14 is a computer-generated representation of the model of FIG. 13 but showing the core portions spaced away from the mold cavities; and

FIG. 15 is a computer-generated representation of the model of FIGS. 13 and 14 showing partial repositioning of the mold cores with respect to the mold cavities.

### DETAILED DESCRIPTION

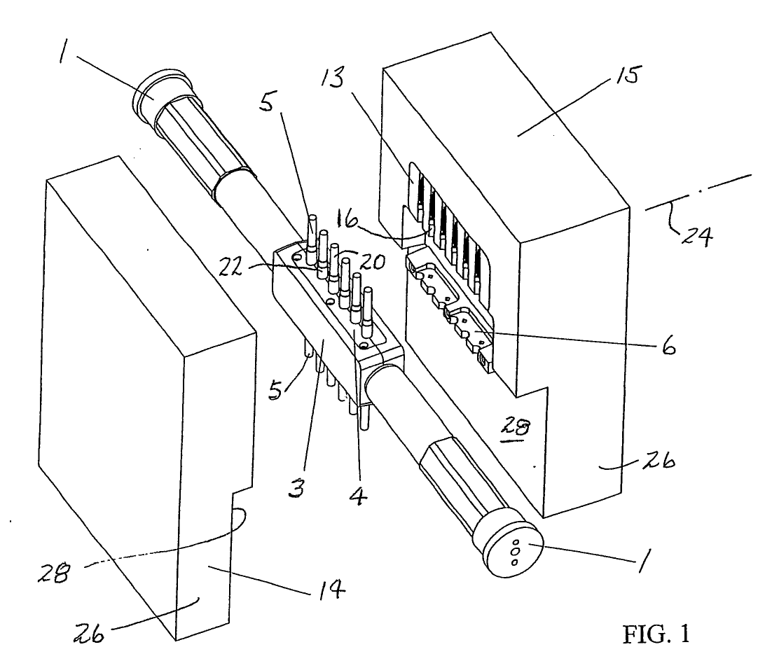

Referring first to FIG. 1, an injection molding machine employs a fixed platen and a moving platen that are aligned with each other, the moving platen being movable toward and away from the fixed platen in a molding cycle. To the fixed platen is attached a stationary or fixed mold half 14, and to the moving platen is attached a moving mold half 15. One or both of the mold halves contains a recessed cavity, Positioned between the mold halves is a turret 3, sometimes referred to as a core nest block. In a molding operation, the mold halves are brought together under pressure with a core positioned between them, the core being borne by a movable turret. Molten plastic, commonly driven by a worm-type extruder, is forced under pressure into the formed space defined by the mold cavity in the core. It is common for the mold halves to contain a plurality of cavities, and for the turret to carry a plurality of respective cores so that a single molding cycle produces a plurality of molded parts.

For ease of understanding, the invention will be described in connection with the molding of a pen barrel, a generally tubular object with an open end and a closed end. It should be understood that the invention is applicable to any injection molded part or shape that is manufactured using mold halves in cooperation with a core.

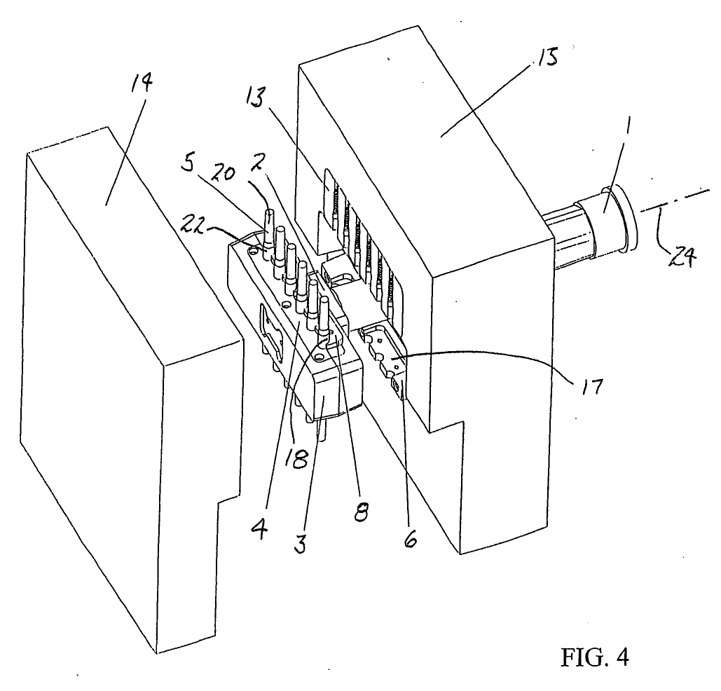

In FIG. 1, the turret 3 includes plurality of cores 5 that extend from opposite sides of the turret. Each core has an outwardly convergent portion 20 defining the interior of a pen barrel to be molded, and also an enlarged portion 22 where the core arises from the turret. As shown in FIG. 1, the cores may be mounted to the turret by means of a core retainer 4 having bifurcated halves that are fastened to the body of the turret. The turret itself is mounted on a spindle 1 that is rotatable about its longitudinal axis through 180° for purposes of facilitating the ejection of previously molded parts, as will be described in greater detail below. The purpose of the spindle is to reposition the cores, and hence the rotational axis of the spindle may be at right angles to the direction of movement along axis 24 of the moveable mold half, as shown in FIG. 1, or may be parallel to the axis 24, as shown in FIG. 4.

The spindle and turret may be carried by a separate carriage that is movable parallel to the axis 24 during a molding operation. The spindle 1 may be carried by the moveable mold half 15, as shown in FIG. 4, or by the moveable platen to which the mold half 15 is attached, and is driven by a motor (electric, hydraulic, pneumatic) in accordance with a program selected by the operator. Spindles, movable turrets, molds and cores and the procedures for their use are well known and require no further explanation.

Referring again to FIG. 1, the moveable mold half 15 includes a series of upwardly elongated cavities 16 formed in a cavity block 13, the latter being attached to the mold half 15. As described further below, a similar series of cavities will be formed in the cavity block attached to the mold block carried by the fixed platen, the mold halves, when closed on each other, defining the outer configuration of a pen barrel in this exemplary explanation. Depending upon the configuration of the desired molded article, the cavities formed in one of the mold faces could be quite different from the cavities of the other, or a mold face could simply be flat.

Referring now to FIG. 4, an ejector insert or shield 8 is shown in position along the base segment 22 of the cores. The ejector inserts comprise plates that are receivable in the tray-like recesses 17 formed in slide ejector portion 6. The insert 8 has a series of half-round recesses 18 along its edge positioned so that when molten plastic is injected into the mold, the ejector inserts 8 shield the base 22 of the core from coming into contact with the molten plastic, thereby leaving a bare area around the base 22. In FIG. 4, the ejector insert is shown mounted on the turret itself for ease of understanding, but it will be understood that the ejector insert actually is carried by tray 17. In FIG. 4, the spindle 1 is shown extending through the movable mold half 15, and includes a nest mount plate 2 upon which is mounted the turret 3.

The invention thus far has been described in connection with the moveable mold half 15. Stationary mold half 14 is provided with a face having recesses essentially identical to those formed in the face of the mold half 15 such that, when the mold halves 14 and 15 are closed upon one another along axis 24, the cavities formed in the stationary and moveable mold halves 14 and 15 will come into registration with each other to form—in this extemporary explanation—the exterior configuration of a pen barrel, and that the cores 20, then, will be positioned within respective cavities, the cavity walls and the core being spaced from one another to define the shape of the pen barrel to be molded. The mold half 14 will similarly carry a slide ejector insert or shield 8 having an edge with half-circle cutouts adapted to engage the other side of the base portions 22 of the cores to shield the cores from contact with molten plastic during an injection cycle.

In the embodiment of FIG. 1, it should be noted that the faces of the mold halves each have a lower portion 26 that is recessed from the upper portion, as shown at 28. Referring to FIG. 1, when the mold halves are closed upon each other and upon the cores, the upwardly extending cores will be received within the cavities 16, but the downwardly extending cores will extend into the space formed by the recessed faces 28.

It will be understood that the molding machines in general have drive systems for driving the moveable platen with its core half into and out of pressurized engagement with the closed platen and its mold half, and the fixed platen is provided with appropriate channels for introducing molten plastic into the cavities formed by the two mold halves when they are closed upon each other. Current molding machines also utilize drive systems for rotating turret so as to bring different cores into alignment with the mold half cavities, and for brevity, these known apparatuses have been omitted from the drawing.

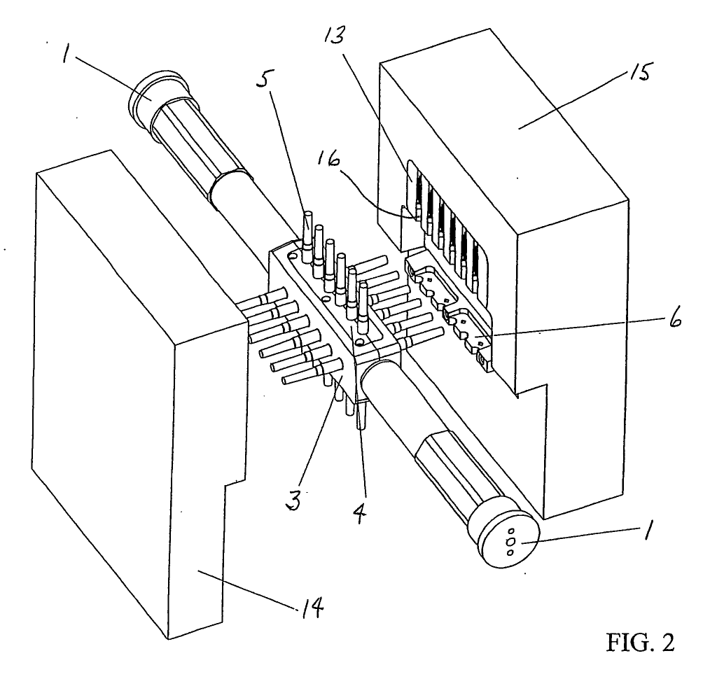

Although shown in FIG. 1 as containing two core-carrying faces, a turret may have as many faces as are appropriate for a given molding situation. In FIG. 2, for example, the turret is generally square in cross section, and has four core-bearing faces, each at right angles to its neighboring face. To accommodate those cores that are positioned at right angles to the cores currently received in the mold cavities, the mold halves 14, 15, are provided with other or further recesses as appropriate to receive these cores. Other operations, such as adding inserts, etc., may be performed on the molded articles carried by the cores prior to their ejection.

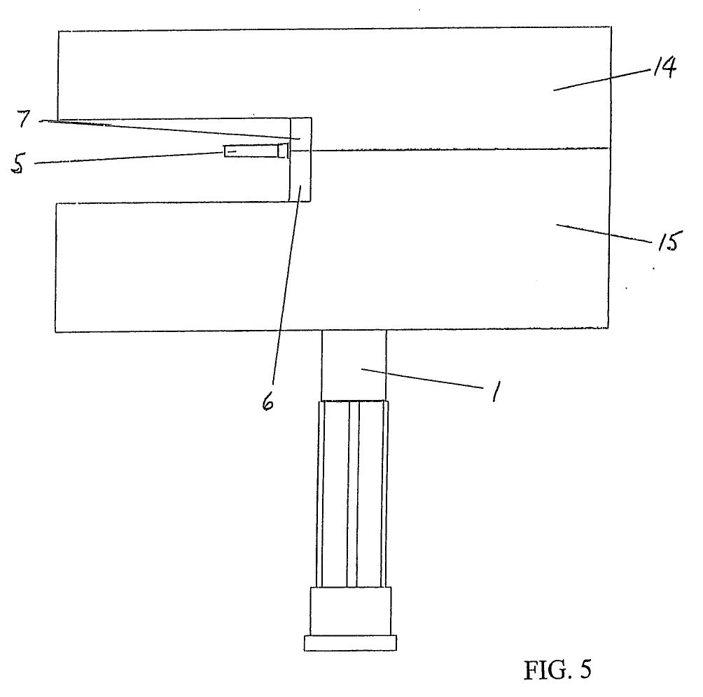

The ejector system, in its preferred embodiment, is configured to operate to eject parts concurrently with the molding of other articles within the cavities. With reference to FIG. 4, for example, once the mold has been closed molten plastic has been injected within the space between the cavity walls and the cores, and the plastic has cooled sufficiently as to no longer require pressure to retain its shape, the mold is opened and the turret is rotated through 180°. In the embodiment of FIG. 4, this simply amounts to rotating the turret about the longitudinal axis of the spindle 1, which is accomplished through conventional means. The cores bearing the molded parts thus become the downwardly projecting cores, and the cores initially projecting from the bottom of the turret now become upwardly extending cores which are free of molded articles and which can again be used in a molding operation. The mold is closed once again, molten plastic is injected, and concurrently with the molding operation, the previously molded pen barrel articles are stripped from the downwardly projecting cores. We turn now to the currently preferred ejector mechanism shown schematically in FIGS. 5-11.

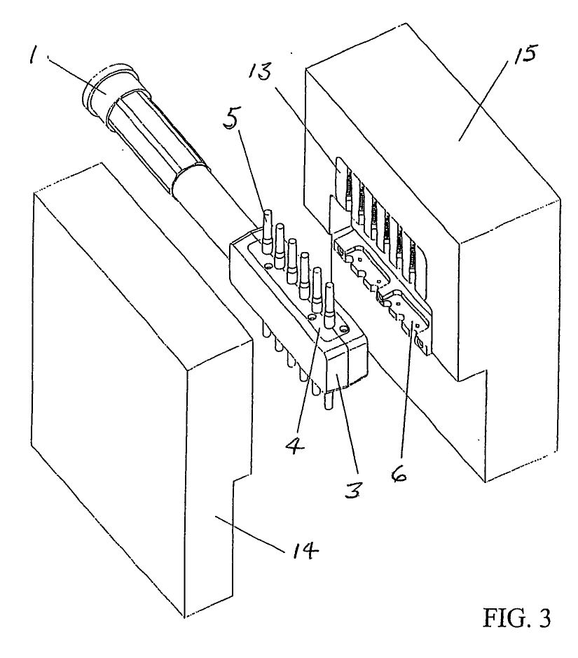

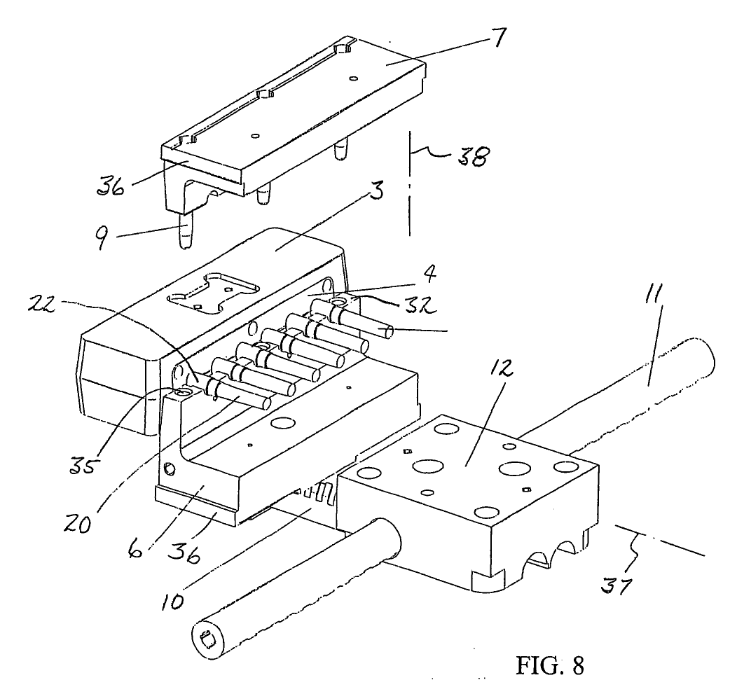

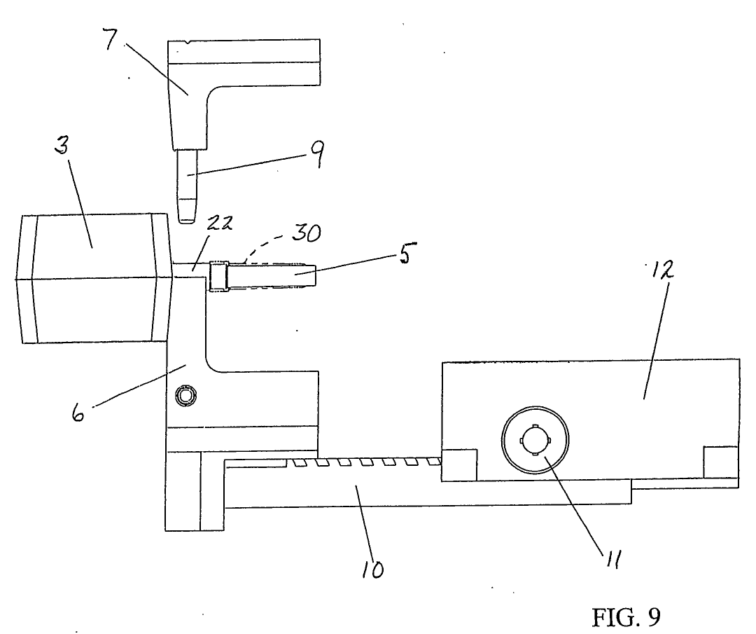

Referring first to FIG. 8, the ejector mechanism includes a pair of ejector portions 6, 7. Ejector portion 6 is shown in FIGS. 1-4, ejector portion 7 being carried by the fixed block 14. In FIG. 8, the cores 20 are shown extending from the turret 3 in a horizontal direction, but it will be understood that the cores shown in this figure are the downwardly extending cores in FIG. 1. With respect to these cores, then, the cores themselves contain the previously molded pen barrels, 30, as shown in FIGS. 9, 10, and 11. The ejectors 6, 7 have confronting faces 32, 33, respectively, the faces having half-round cut-outs 34 that are adapted to close open the base portions 22 of the cores when the mold halves are closed upon each other. The ejector portion 7, which is carried by the stationary mold half 14 has spaced alignment pins 9 extending from it that are received in respective guide holes 35 formed in the face 32 of the ejector portion 6, thereby assuring correct registration of the ejector portions 6 and 7 as the mold halves are moved to their closed position. When the ejector portions 6, 7 are closed upon each other, their recessed or cutout faces 34 engage the base portions 22 of the mold cores.

It may be noted that the cutouts in the slide ejector insert 8 are carefully machined so they closely engage opposite halves of the base portion 22 of each core. These inserts preferably are made up of a metal that is at least slightly softer than the metal of the cores, such that any wear caused by engagement of the cores and the inserts is born by the inserts rather than by the cores. Worn inserts are readily replaceable.

Referring again to FIG. 8, there is provided a mechanism for moving the ejector portions 6,7 in a direction away from the turret 3 to strip the previously molded pen barrel parts from the cores. Although a variety of mechanisms can be employed, the drawing exemplifies a drive support block 12 from which extends a primary ejector drive shaft 11,* the later in turn having teeth engaging the teeth of a secondary ejector drive shaft 10 that is coupled to the ejector portion 6. Thus, when the ejector portions 6 and 7 are closed upon each other, operation of the primary ejector drive shaft causes the ejector portions 6, 7 to move as a unit away from the turret, the ejector portions encountering the ends of the molded pen barrel articles and stripping these articles from the cores. Reversal of the drive shaft direction will bring the ejector portions back to their original positions. Note that ejectors 6 and 7 have outwardly extending side edges 36 (FIG. 8) that are engagable in complimentary slots carried by the mold halves to facilitate the movement of the combined ejector portions as a unit away from the turret 3 in the direction depicted by the arrow 37 in FIG. 8.

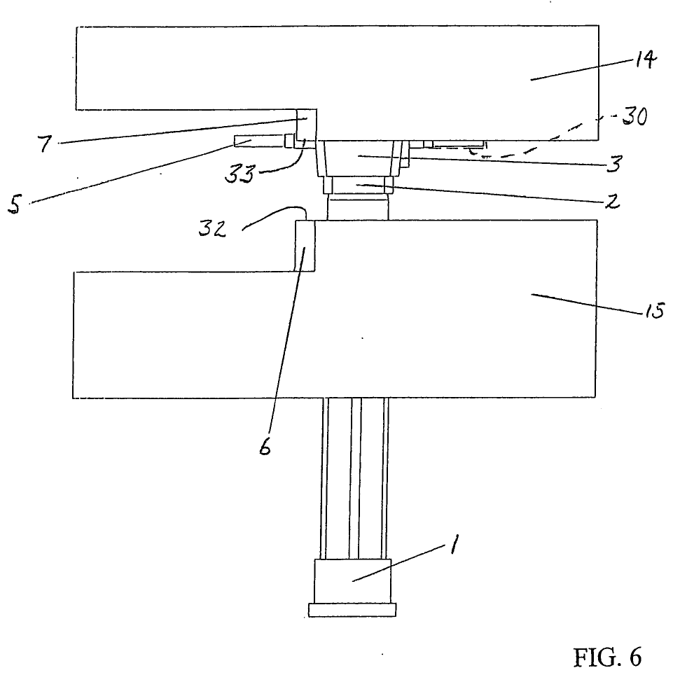

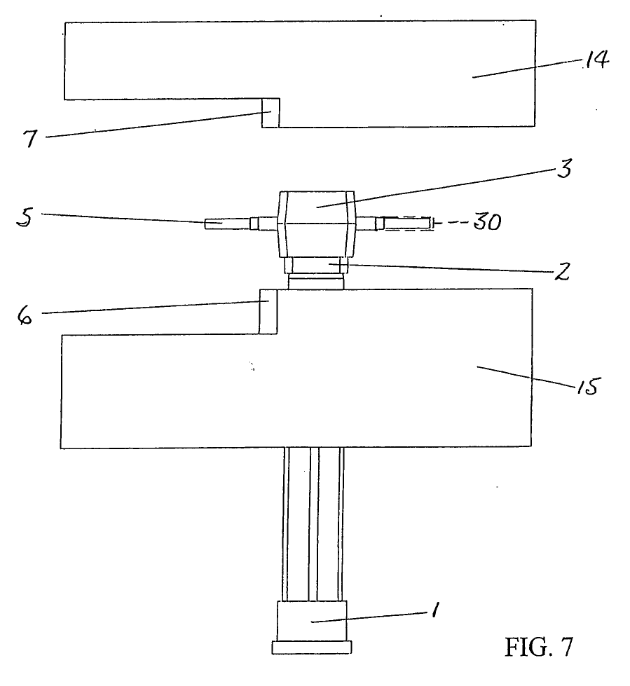

FIG. 5 shows schematically the mold halves 14, 15 closed upon one another and the ejector portions 6, 7 accordingly closed upon the bare base portions 22 of the cores 5. Molten plastic is injected into the cavities formed by the closed mold halves about those respective cores 5 that extend to the right in FIG. 5. The ejector insert 8, during this procedure, serves as a shield to shield the base portion 22 of the cores 5 from contact with the molten plastic. The plastic hardens under pressure in the mold and once sufficient time has passed to enable pressure to be reduced without injury to the part (sometimes called the “pack and hold” period), the movable mold half 15 is withdrawn from the fixed mold half 14, as shown in FIG. 6. The core portions 5 extending to the right of the turret in FIG. 6, at this point, contain molded articles 30. The mold halves are moved further apart, and the turret 3 is drawn away from the stationary mold half 14, all is shown in FIG. 7. The spindle 1 is rotated through 180°, bringing clean cores into registration with the mold half cavities.

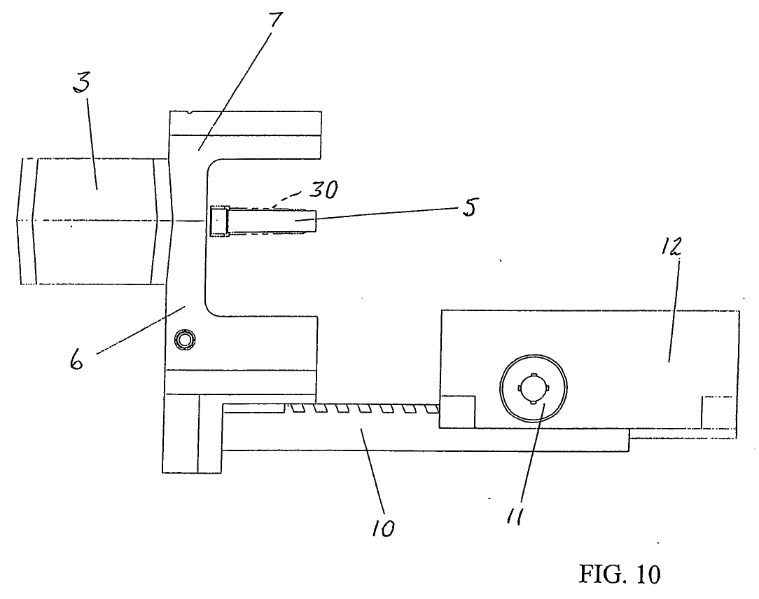

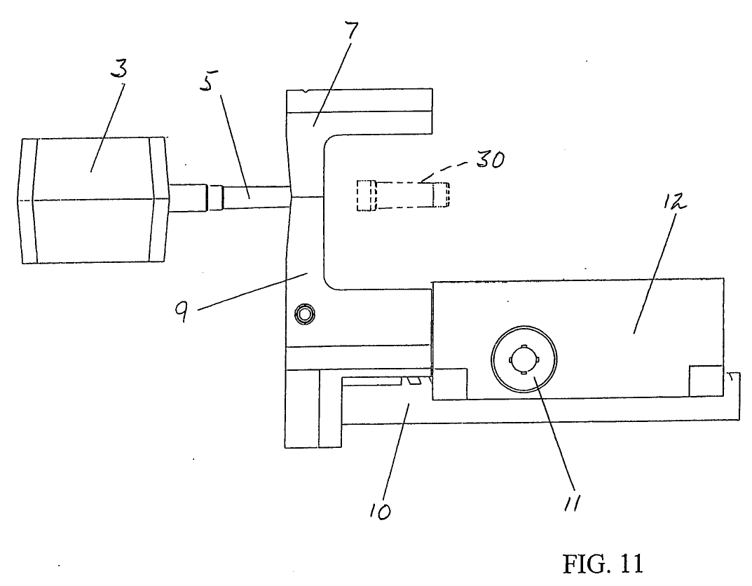

The moveable mold half is then moved toward the other mold half to bring its ejector portion 6 into contact with the bare base portion 22 of the core, as shown in FIG. 9. Concurrently, alignment pins 9 are received in the alignment pin receptacles 35, and the cutout portions 34 of each of the ejector portions is closed upon the bare base portions 22 of the cores, as schematically depicted in FIG. 10. Operation of the primary ejector drive shaft 11 then causes the ejector portions 6 and 7 to move as a unit away from the turret; that is, to the right in FIG. 11, thereby expelling the articles 30 from the core 5.

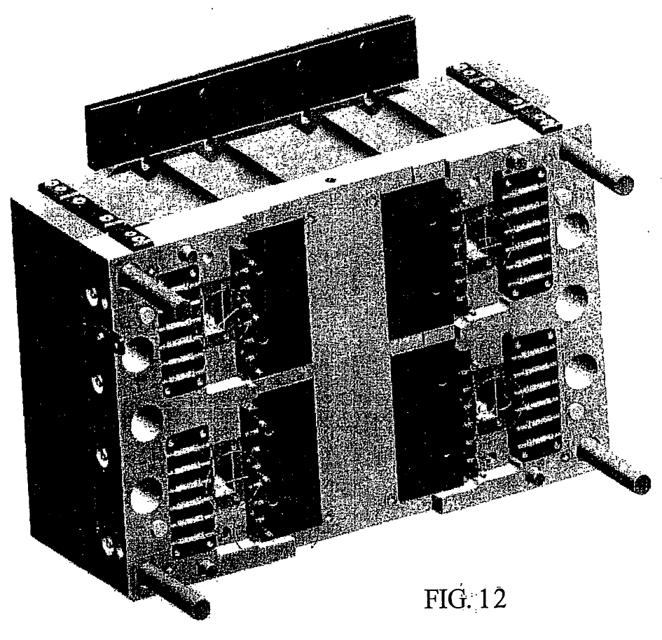

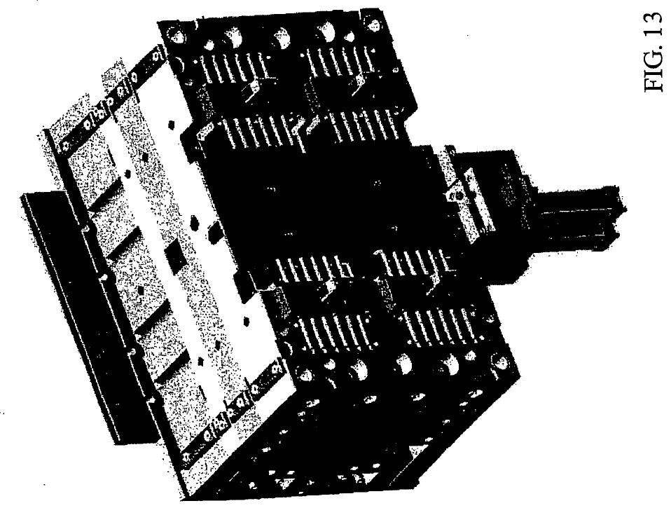

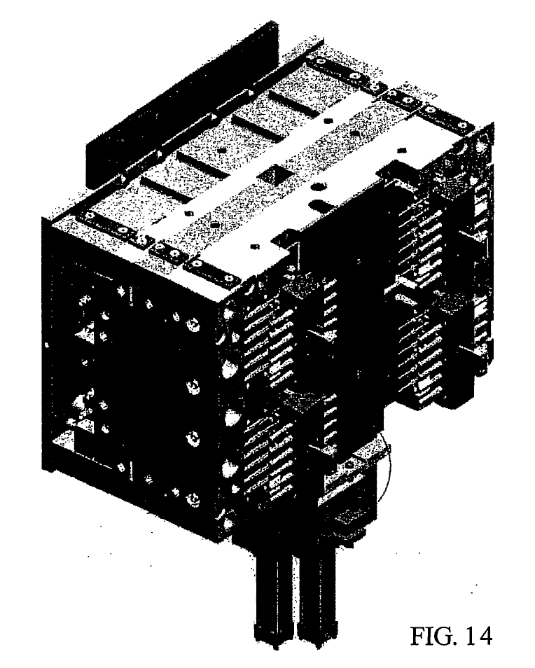

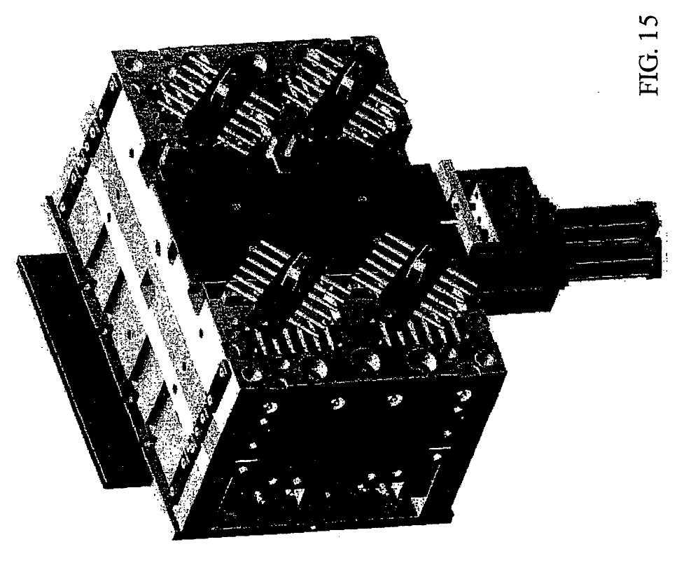

FIGS. 12-15 show computer-generated models of the molding equipment described above. FIG. 12 shows the face of the fixed mold half; FIG. 13 shows the opposing face of the movable mold half with the turrets and cores in place in the cavities. In FIG. 14, the turrets with their respective cores have been moved away from the moveable mold half. If this occurs directly after a mold shot, then the cores extending generally to the left in this FIG. 14 will bear a molded part, whereas the cores extending generally to the right in this figure will have been stripped of their molded parts and are ready for reuse once they are rotated back into position. FIG. 15, finally, shows the turrets being rotated through 180°, in the manner schematically shown in FIG. 4.

Returning now to FIG. 8, it will be appreciated that the ejector portion 7 moves first in a direction shown by arrow 38 to close it upon ejector portion 6 so that they can function as a unit. Subsequently, the ejector portions 6, 7 as a unit are drawn generally to the right in FIG. 8, as shown by arrow 37. That is, the ejector portions move first in one direction, and then in a different direction. In the device I exemplified in the above description, the directions of movement along arrows 38 and 37 are at right angles to one another, but it will be understood that the directions of movement may depend to some extent upon another variables such as the shape of the molded part.

Although described above in connection with the injection molding of pen barrels, it will be understood that the invention pertains to molding of a variety of plastic articles in which the article is carried, at one stage in the molding cycle, by a core from which it may be ejected.

1. Injection molding equipment for use with an injection molding machine having a fixed platen and a movable platen, the equipment comprising a first mold half having a cavity and carried by the fixed platen, a turret having separate faces carrying respective cores, the turret being rotatable about an axis to bring respective cores into alignment with said cavity and the turret being movable in a direction to bring respective cores into and out of registration with the cavity as the mold is closed and opened, respectively, the cavity and each core, when so registered, at least partially defining a mold volume for the reception of molten plastic, said turret and said first mold half being so configured that when one core is in registration with the cavity, another core carrying a previously molded article and not in registration with the cavity is positioned for ejection of the molded article; and an ejector for ejecting previously molded articles and having cooperating, molded article-engaging portions, at least one of said portions being movable in a first direction to close upon another ejector portion adjacent the molded article, said ejector portions, when closed, being movable in a second direction causing said article to separate from the core upon which it was molded.

2. The equipment of claim 2 wherein said first direction is at right angles to the second direction.

3. Injection molding equipment for use with an injection molding machine having a fixed platen and a platen movable in a direction toward and away from the fixed platen, the equipment comprising first and second mold halves carried respectively by the platens and closable upon each other to provide a mold cavity between them, a turret carried between the platens and having separate faces carrying respective cores that are receivable in the cavities to define mold shapes for the reception of molten plastic, the turret being rotatable about an axis to bring respective cores into alignment with said cavity, and the turret being movable along said axis to bring respective cores into and out of reception in respective cavities as the mold is closed and opened, respectively, said turret and mold halves being so configured that when one core is received in a cavity, another core carrying a previously molded article is positioned outside of the cavities for ejection of the previously molded article, the machine including an ejector for ejecting previously molded articles, the ejector having opposed, cooperating, molded article-engaging portions, at least one of said portions being movable in a first direction to close upon an opposed article-engaging second portion, and said ejector portions, when closed, being movable in a second, different direction to cause said article to be ejected from the core upon which it was molded.

4. The equipment of claim 2 wherein said first direction is at right angles to the second direction.

5. The equipment of claim 3 wherein said first direction is parallel to the direction of movement of the movable platen.

6. The equipment of claim 3 wherein said mold halves include shields extending into contact with the cores when the mold is closed and plastic is injected therein to provide a substantially plastic-free area on the cores, and wherein said ejector portions are positioned to close upon the substantially plastic-free areas.

7. The equipment of claim 3 wherein at least one of said mold halves includes a first portion cooperating with the other mold half to define a cavity, and a second portion defining at least one recess to receive a core spaced from the cavity and carrying a previously molded article.

8. The equipment of claim 7 wherein said turret has two opposed core-bearing faces, the turret being rotatable through a 180° arc to reposition cores bearing previously molded articles from positions adjacent said first mold half portion to positions within said recess.

9. The equipment of claim 3 wherein said ejector is movable to eject previously molded articles concurrently with the injection of plastic into said cavities.

10. The equipment of claim 7 wherein said turret has four core-bearing faces and is rotatable through 90° arcs to reposition cores bearing previously molded articles from positions adjacent said first mold half portion to positions within said recesses.

11. Method of ejecting an injection-molded article, comprising providing opposing mold halves and a mold core, providing an ejector having portions closeable upon each other about the core, injection molding an article about the core, removing the core bearing the molded article from the mold halves, closing the ejector portions with at least one ejector portion moving in a first direction toward the core, and moving the closed ejector portions as a unit in a second direction to engage and eject the molded article from the core.

12. The method of claim 11 including providing opposing mold halves with portions positioned to engage the mold core and to provide the core with a substantially plastic-free area adjacent a molded article carried by the core, the ejector portions being closed upon the plastic free area.

13. The method of claim 12 wherein the core is borne by a face of a multi-faced rotatable turret positioned between the mold halves, the method including rotating the turret to reposition the core.

14. The method of claim 13 wherein said multi-faced turret includes cores carried by opposing turret faces such that a core carried by one face is received in a mold cavity defined by said mold halves while a core carried by the opposed face bearing a previously molded article is positioned in a recess defined by the mold halves, and wherein said one ejector portion is moved in said first and second directions to eject said molded article concurrently with the molding of another article in the mold cavity.

15. The method of claim 12 wherein cores are borne by each of four faces of a multi-faced rotatable turret positioned between the mold halves, the method including rotating the turret through sequential 90° arcs, and wherein injection of plastic into the cavities and ejection of a previously molded part occurs after each 90° rotation.

16. The equipment of claim 7 wherein said ejector is movable to eject previously molded articles concurrently with the injection of plastic into said cavities.
